(19) United States
(12) Patent Application Publication
(10) Pub. No.: US 2026/0015989 A1
(43) Pub. Date: Jan. 15, 2026

(54) ROBOTIC ENERGY CONVERTER AND A SHIP COMPRISING A ROBOTIC ENERGY CONVERTER

(71) Applicant: AEWH B.V., Waalwijk (NL)

(72) Inventor: Johannes Jacobus Hubertus PAULIDES, Waalwijk (NL)

(21) Appl. No.: 18/996,349

(22) PCT Filed: Jul. 18, 2023
(86) PCT No.: PCT/NL2023/050386

§ 371 Date: Jan. 17, 2025

(30) Foreign Application Priority Data
Jul. 19, 2022 (NL) 2032548

(51) Int. Cl. F03B 13/18; B63B 39/10

(52) U.S. Cl. CPC F03B 13/181; B63B 39/10; F05B 2240/40; F05B 2240/93

(57) ABSTRACT

The present invention is related to a robotic energy converter, for converting movement of a movable object into on average usable energy, in particular electrical energy, comprising at least one base structure, wherein said base structure is, directly or indirectly, connected or connectable to a fixed world, at least one kinematic chain comprising at least one link and at least one joint, wherein a first end of the at least one kinematic chain is, directly or indirectly, connected to the at least one base structure, and wherein a second opposite end of the at least one kinematic chain is connected or connectable to a movable or moving object, wherein the robotic energy converter comprises at least one energy converting unit. The present invention is also related to a ship comprising a robotic energy converter.

The present invention is related to a robotic energy converter, for converting movement of a movable object into on average usable energy, in particular electrical energy. The present invention is also related to a ship and/or floating structure provided with a robotic energy converter according to the present invention.

In the past years, automation is becoming an industry standard. Where, decades ago, most of the tasks in for example car industry were executed by humans, this has changed. Nowadays, more and more robots are utilized for executing, in particular repetitive, tasks. It is by means of a non-limitative example, undesirable for a human to perform the task of screwing and/or unscrewing hundreds of bolts on a single location every single day. The chance of a human error such as a wrong bolt that is used, or a bolt that is tightened too much or too little may easily occur after a while. By using a robot, which may be programmed to perform exactly the same operation time after time, this chance may significantly be reduced. Use of robots may also reduce heavy burden tasks that require multiple humans, since a single robot may be designed such as to suffice in executing the task. Processes may be streamlined by means of said robots, and the manufacturing speed may be increased. A significant amount of these robots is of the manipulator type, which may be referred to as robotic arms. These manipulators typically may have up to six degrees of freedom.

Hence, use of robots in manufacturing processes has proven to be highly efficient in terms of operational cost, and processing times. Yet another benefit of the usage of robots is that a robot may be reprogrammed for performing a different task. In addition to programming robots for performing a specific task in a manufacturing line, the latest trends are ongoing to allow different robots to mutually collaborate on a single task. This is more complicated since the robots need to determine together whether a specific location is free to operate, and hence to prevent collisions between robots. Further, also humans and robots are slowly working together in the same environment, this means that a human should be able to stop the robot or in case of collision have limited impact. The robot programming requires a stiffness in this case in the movement and in case the torque of a single, or multiple, axis exceed a certain threshold, the robot should come to an immediate stop.

Although the automation of processes by using robots is beneficial to the availability of product for a wider public, it may come at a cost. First of all, the robots use significant amounts of electric energy, and as such may put a burden on the environment. Especially when more than one robot or robotic arm are required, the need for electric energy may raise even more. Often, production plants run 24/7, and hence solar panels, or other renewable sources, may only partially cover the cost of operation during daytime. The excessive usage of energy by these robots is a problem that needs to be tackled. The past years the studies into the energy consumption of robotic arms try to reduce the amount of energy used during operation of the robot. This may partially be achieved by means of path optimizations and the like.

The abovementioned optimization of the energy consumption is however not sufficient to cover the energy usage. There is thus a need for a more environmentally friendly solution in the use of robots. Not only that, but there is also a general need for an environmentally friendly way of harvesting energy in a more flexible and predictable manner. Wind and solar energy have the downside that their energy density is dependent on a weather forecast, which may significantly deviate from the actual weather. This may cause an excessive energy peak or an energy low, which may cause trouble in the energy network. The need for an environmentally friendly way to provide a predictable and easily applicable source of usable energy is therefore large. Preferably, said source of energy is easily deployable and scalable. This may resolve not only local energy requirements, but may also contribute to regional and/or national energy solutions in a broader sense.

It is therefore a first goal of the present invention to provide for an energy converter that may be more widely applicable.

It is a second goal to provide for an energy converter that may provide for a better contribution in levelling the local or global electricity network.

It is a third goal of the present invention to provide for a robot that is essentially energy neutral, preferably energy positive. Further, it is a goal to provide for a robot that is able to deliver energy.

The present invention thereto proposes a robotic energy converter, for converting movement of a movable object into on average usable energy, in particular electrical energy, preferably comprising at least one base structure, wherein said base structure is, directly or indirectly, connected or connectable to a fixed world, at least one kinematic chain comprising at least one link and at least one joint, wherein a first end of the at least one kinematic chain is, directly or indirectly, connected to the at least one base structure and/or to a fixed world, and wherein a second opposite end of the at least one kinematic chain is connected or connectable to a movable or moving object, preferably wherein the robotic energy converter comprises at least one energy converting unit, for converting the movement of a movable object connected to the second end of the kinematic chain into usable energy, preferably electrical energy.

Preferably, said at least one base structure may be rigidly connected to a fixed world. In this respect, the present invention is not limited to fixed world as such. That is, instead of a fixed world, a floating world may be understood as a fixed world according to the invention. The floating world is preferred to be substantially stable on or at a water surface. That is, the floating world should be able to provide for a substantially stable point of origin with respect to the at least one base structure for supporting the robot energy converter according to the invention, and preferably to provide for a frame of reference for said robot energy converter. At least, the mass moment of inertia of the fixed or floating world should be significantly larger compared to that of the movable object. However, the inverse may also be possible, as such the movable object will as such form the point of origin for the robotic energy converter. Alternatively, the at least one base structure may be connected to or on a structure, whilst allowing the at least one kinematic chain to move in height with the water level, for example tidal fluctuation or river water height like ‘Normal Amsterdam Level (N.A.P.)’. It is conceivable that a floating wind turbine foundation, e.g., a trifloater, may form a part of the fixed world, or floating world, according to the present invention. Such a trifloater may form a relatively stable point of origin for mounting the robotic energy converter. Applying such a floating world may provide for automatically following the tide of the water, which may allow the robotic energy converter to provide for a more stable generation of energy since the distance from the robotic energy converter (in particular its base structure) to a water base level is more constant. It is conceivable that a buoyancy of the floating world is at least partially adjustable. For example by means of adding and/or removing weight increasing substance, such as water, from an interior volume of said floating world. Preferably, the at least one base structure is connected to the fixed world above a water surface level.

It is conceivable that the base structure is mounted, preferably to the fixed world, in a substantially vertical direction. A mounting surface of the base structure may be oriented in a substantially vertical plane. It is also conceivable that the base structure is mounted in a substantially horizontal direction wherein the robotic energy converter is facing downwardly. Preferably, the joint of the kinematic chain is connected to the base structure, wherein the joint is configured for rotating in a substantially vertical plane. This embodiment is in particular advantageous if the kinematic chain is formed by a robotic arm. Normally, the base structure of a robotic arm is to be mounted horizontally, wherein the arm is facing upwardly. However, it was surprisingly found that mounting the robotic energy converted according to the embodiments described above allows for generating more energy since no forces need to be applied to prevent the kinematic chain from collapsing since it may just bungle or hang down. Hence, only energy may be generated. It may also allow for easily mounting the robotic energy converter above a water surface level which may reduce the effect of corrosion due to for example salty air or moisture. Preferably the at least one kinematic chain is suspended to or from the at least one base structure.

By means of the at least one kinematic chain a movable object is connectable (directly or indirectly) to the aforementioned fixed (or floating as elaborated) world. Preferably, said kinematic chain is movably connected to the base structure, such as to allow the kinematic chain to move with respect to said base structure. In this respect, it is conceivable that the at least one joint of the kinematic chain is connected or connectable to the base structure, but it is also conceivable that the at least one link is connected or connectable to the base structure. Preferably, the at least one link, preferably all links, of the at least one kinematic chain are substantially rigid or flexible links. It is preferred that the link is substantially rigid. An example of a substantially rigid link the following may be understood: a beam, a rod, a stiff connection, a damper, “a spring, an inverter, an electric generator, a generator via a gearbox, a hydraulic/pneumatic converter or any other means that allows for energy conversion of at least one joint. A rigid, or substantially rigid link may prevent that energy of the movable object (e.g., the kinetic energy of the movement as such) is absorbed by the link. A rigid link may allow said kinetic (or other form) energy to be transferred to, and preferably through the at least one joint. The connection between the at least one kinematic chain and the movable object may be in different forms, also the wording movable object must be broadly understood. Movable object may for example be an object that follows an induced movement, such as for example a buoy that is floating on a water surface level. The movable object may thus also be understood as an oar, floating turbine, or another object that is external to the robot and has sufficient energy to move the manipulator and generate energy, preferably electrical energy. Said buoy, or otherwise floating object may be forced to move via waves in the water surface level. Yet, the movable object may also be a pier, or a quay, or a bollard that is present on a pier in that respect. In this non-limitative example, it is not per se the object that moves, but if e.g., the base structure is attached to a ship, and said ship thus functions as a fixed world, said pier, quay, or bollard thus moves with respect to the fixed world. The mutual movement between the base structure and the pier, quay, or bollard provides for a movement that is subject to a certain energy. Energy that may otherwise have moved the ship along with the waves, tide, and/or changing water level, or be, partly, absorbed by buoys between wall and ship, may also be extracted by the robot energy converter and converted into for example electricity which may be used on the ship. Also the energy conversion, for example absorption of energy can be utilized to stabilize the ship and minimize excessive movements. Hence, said pier, quay, bollard or the like may equally well be a movable object. To this end, the second end of the kinematic chain may thus be attached, or attachable to said pier, quay or bollard and the first end of the kinematic chain may be attached to the base structure. This is however to be interpreted merely as an example, more alternatives are conceivable. It is preferred that the second end of the kinematic chain is releasably connectable to any movable object. To this end, it may be preferred that said movable object comprises an attachment element. Said attachment element may be configured for engaging with the second end of the kinematic chain such as to establish a mutual coupling between the kinematic chain and movable object. Said attachment element may for example also be provided to the second end of the kinematic chain, and mounted to the movable object by means of bolts and/or welded and/or rivet and/or glued and/or screws and/or a hook, and/or an mechanical or automated interlocking mechanism. As such, the movable object may also be detached from the kinematic chain, which may in some instances be preferred (such as on a ship, wherein the kinematic chain may be attached or attachable to aforementioned bollard). The second end of the kinematic chain may be connected (or connectable) to the movable object such that it may be pulled up, or down, to extract the movable object, preferably embodied as a buoy, from the water. This extraction can be to prevent damage to the energy conversion and/or in case the energy generation is no longer needed. It is preferred that the movable object is an external object, such as a buoy, or the like. Hence, the at least one kinematic chain may as such be connected or connectable to a wide variety of movable objects. It is in particular preferred that the movable object is subject to a repetitive movement and/or a predictive movement. In this respect, a predictive movement would allow to know in advance the amount of energy that may possibly be converted into electrical energy, and hence the robotic energy converter may thus provide for a reliable source of electrical energy. It is imaginable that at least a part of the energy harvested out of the movement of the movable body may be reused for repositioning the movable body. By means of a non-limitative example; when the movable body is a buoy floating on the sea and/or ocean, it is subject to a movement induced by the water surface level of the sea/ocean. Although water particles of the sea/ocean are subjected to a substantially circular movement, the buoy will typically float away slightly by the waves that induce the movement. However, the amount of energy that may be extracted from the movement of a wave via said buoy is significantly larger than the energy required to reposition the buoy (slightly) such that it does not, or less, floats away. Hence, retracting the buoy to an initial position to account for drifting of the buoy, for example due to surface current that may be local or global. By using a portion of the energy that is harvested to return the buoy to said initial position, the robotic energy converter may fully operate on its own, whilst ensuring the buoy will not drift away. Note however, that aforementioned example is non-limitative, and the same holds for other movable objects. Thus, a portion of energy extracted from the movement of the movable object may optionally be utilized to relocate the movable object. It is conceivable that the buoy, or if a plurality of buoys are used, the combined number of buoys, has a weight of at least 15.000 kg, in particular at least 25.000 kg, preferably at least 45.000 kg. However, it is also conceivable that different buoys are used.

In a preferred embodiment a rudder function of a ship may be combined with harvesting energy. The rudder movement could be used to, partly, stabilize the ship, or any other floating structure. When the floating body in its form as a movable object according to the invention is stationary or moving slowly, the rudder could be used to harvest electrical energy. To this end, it is conceivable that the at least one kinematic chain is connected or connectable a rudder, such that movement of the rudder may be transferred to the kinematic chain.

In another embodiment the robotic energy converter comprises an energy source in the form of the wind energy. Energy from the wind may be harvested in such an embodiment by forming a movable object out of an object having a significant large surface area, e.g., a tennis bat shape, such that said surface area is catching the wind. This object may as such be forced to move by means of wind. The wind may e.g., rotate such an object, for example a fly wheel or a wind turbine, or propel it, or translate it, such as a piston, out of which energy may be extracted. This may be, but is not limited to, a combination of the water movement as very large water movement is very destructive. What may be utilized is the wind in case the hole platform is rotated so as to still produce energy even in excessive waves. The movement can vary from being a wave tail shape, or like a hummingbird.

In yet another example the robot manipulator is provided with solar panels, preferably oriented in the direction of the sun. In case there is a limited amount of wind, the robot manipulator may be used to take more advantage of the solar panel. It may be considered that the tennis bat shaped movable object, such as that used for the wind harvesting has solar panels mounted on it. Also a buoy may be combined with solar panels.

In another example the robotic energy converter and/or floating body comprises at least one stabilizing element, preferably a submersed or submersible element, such as a plate, for stabilizing the floating body. Said submersible plate may act as stabilizer to harvest energy from moving water. It is also conceivable that the robotic energy converter and/or floating body comprises at least one flow conducting element, for introducing a movement into the at least one floating body through a fluid flow. It is imaginable that the stabilizing element may act as a flow conducting element. The movement may originate either from a floating body that is powered, and/or a floating body that is moored with water flowing past it, and/or a floating body that is moved by the wind using a kite or sails, or any other means. For example the plate may also be hinged on one side and moved by a car driving over it. Yet, alternatively by any externally excited vibrating source.

The robot energy harvesting is preferably optimized for harvesting, this might mean that friction losses and/or gravity compensating spring, that are nowadays often present on the robot, may be eliminated and/or adapted. In the extreme case all axis could be direct-drive, in which case no gearbox is present between a joint and an electrical energy harvester, however this will result in large generators, preferably of the electrical type. Further, currently robots are often optimized for minimal backlash, which may be described as a movement of the gearbox when the movement is for example changed from clockwise to anticlockwise. Minimal backlash is very good for robot accuracy, but not very good for robot generating efficiency. Preferably, the at least one kinematic chain, or robotic arm if applied, is free of gravity compensation, such as a gravity compensating spring and/or balance mass. It is imaginable that the at least one kinematic chain or robotic arm, in particular each link thereof, is freely suspended. This may allow for more energy to be harvested since such balancing masses or compensating springs may assist in the movements made by the kinematic chain and hence reduce the amount of energy to be extracted from such movement. Preferably, adjacent links and/or joints are substantially unsupported. It is conceivable that a movement of, and/or moment induced by, and/or force induced by, and/or kinetic energy of, the movable object is essentially entirely routed through the at least one kinematic chain, in particular one or more joints thereof. More preferably, a magnitude and/or sum of the movement of, and/or moment induced by, and/or force induced by, and/or kinetic energy of, the movable object is essentially entirely routed through the at least one kinematic chain, in particular one or more joints thereof. by gravity

Preferably, the robotic energy converted comprises an energy converting unit, such as a generator, for converting the movement absorbed or transferred to the at least one kinematic chain, into usable, preferably electrical, energy. Since the base structure, preferably also the end of the manipulator with at least a single joint, may be attached or attachable to a wide variety of surfaces and locations, the robotic energy converter according to the present invention may be widely applicable. This may provide for an efficient, and local source of energy. Since the robotic energy converter is locally applicable, and also in a wide variety of applications, it may contribute, at least in some instances, to balancing the factory, ship, local or global electricity network. That is, the robotic energy converter may provide for a different source, separate and preferably independent of the weather conditions. The at least one generator may be coupled to an electricity grid directly, such as to provide for a direct energy supply. However, it is also conceivable that the at least one generator is connected to a local DC or AC load, such as a battery and/or electrolysis to create hydrogen or any other type of fuel. This may be adjusted according to the local necessities. Also, since an energy converting unit of the robotic energy converter is configured to transfer an energy present in a movement of an object into usable, electric, energy, an energy positive robot may be established.

According to a preferred embodiment, the energy converting unit comprises at least one generator, in particular a rotational generator, wherein at least one joint of the at least one kinematic chain is at least partially formed by said generator, for converting a rotation of a link connected to said joint into usable energy. It is preferred to extract the energy from the movement as close to the source as possible, to reduce the losses incurred by the transfer of said movement. Hence, the joints allow for the movement of the kinematic chain, and are in fact the first part in the transfer of the movement from the movable object to the base structure. Therefore, it is the most efficient to extract energy out of the rotational movement present in said joints. It is therefore preferred to provide for a rotational generator. It is conceivable that at least one generator as such forms a joint. Hence, movement of a link connected to said joint directly transfers the rotational movement of the link into usable electric energy via the generator. It is also conceivable that more than one generator, such as two generators or three generators, in parallel and/or in series, form a single joint of the kinematic chain. Preferably, the at least one energy converting unit comprises a plurality of generators, wherein each joint of the at least one kinematic chain is at least at least partially formed by at least one generator, for converting rotational movement between adjacent links into usable energy. As such, energy may be extracted from all the respective movements of joints and links, which may optimize the energy extraction of the robotic energy converter. Optionally, at least one link and/or at least one joint comprises at least one actuator, for actuating said at least one link and/or said at least one joint. preferably wherein said at least one actuator is formed by at least one generator, if applied. It is conceivable that the at least one kinematic chain is an active chain, preferably wherein one or more joints and/or links are movable by means of an actuator. It is conceivable that the active kinematic chain allows for preventing collisions of the kinematic chain with objects that may otherwise damage the kinematic chain. Tha latter may in particular be conceivable in combination with a communicative control unit, if applied. Preferably, each joint and/or link is movable by one or more actuators. Preferably, at least one joint is formed by an actuator, in particular a generator which may allow for actuating, such as an electric motor. Preferably at least one joint of the at least one kinematic chain comprises a transmission, for reducing a required input torque or force. It is conceivable that the at least one joint, in particular the at least one transmission, comprises play. The play in the joint and/or transmission may allow for generating more energy. Where play is generally unwanted in case kinematic chain is a robotic arm, this is beneficial in the present invention since it may provide for more generation of energy. The robot energy converter tries to generate as much energy as possible, based on every displacement of the movable object. In particular due to inaccuracies in the positioning of at least one kinematic chain, the displacement of the at least one kinematic chain increases. This may result in an increasing amount of generated energy. The inaccuracy may be between 0.5% and 8%.

Where according to the prior art, a trajectory of a robot is optimized is optimized in energy consumption, the present invention governs an adapted approach. That is, energy optimization trajectory according to prior art holds that the robot may be moved with the lowest amount of energy from one point in space to the next. However, in a robotic energy converter, maximum point power tracking is required that yields a completely new insight in maximum energy generating trajectory. That is, according to the present invention, it is preferred that the maximum amount of energy may be extracted from one point in space to the next. Motion controllers are preferably differently optimized and selected to this end. Especially in case the cause of movement, such as a buoy, has a significant mass, but limited a speed a multiple joint manipulator may be more useful to divide the force and increase the speed by maximizing the movement. For example a single degree of freedom, i.e. up and down, movement can be transformed into a six degree of freedom manipulator movement. An increased speed with reduced force results in a smaller generator size. A high force, low speed direct-drive generator is larger for the same output power as a faster, with lower force, equivalent.

Programming of the maximum generating motion profile may be undertaken with currently available parameters as ‘Soft Act’ or equivalents, however a motion profile, for example, augmented by vision and energy source prediction will provide for further system efficiency optimization. Especially when considering high energy yield, this maximum generating motion profile is key for applications that are high force with relatively low speed, in case of waves 10 kN's, about 0.1-0.2 Hz, hence low speeds.

Preferably at least one generator and/or multiple generators are connected to at least one power processing unit. Said at least one generator and/or multiple generators may be located in a single joint, or in different joints or parts of the robotic energy converter. This at least one power processing unit is configured for converting the electrical energy to allow configurations of multiple generators in a parallel, series, and/or any other configuration. It is also conceivable that said power processing unit is configured for allowing configurations of generators of different robotic energy converters (if applied). Hence, a number of robotic energy converters may be connected to a single power processing unit. The at least one power processing unit may comprise, but is not limited to, of a full bridge rectifier, inverter, matrix inverter, or any other power electronics unit that may be placed between a generator, or multiple generators, and the grid. Sharing of energy is something that needs to be accounted for when multiple generators are connection to the grid via the at least one power processing unit. Preferably the generator and power processing unit are of high efficiency such as to extract the highest amount of energy from the movement of the movable object.

According to a preferred embodiment, the at least one kinematic chain comprises at least 3 or more degrees of freedom. It is preferred that the at least 3 degrees of freedom are rotational degrees of freedom, in particular a combination of pitch and roll degrees of freedom, such as roll, pitch, pitch as seen from the base structure to the second end of the kinematic chain. More preferably, the at least one kinematic chain comprises at least 6 or more degrees of freedom. Although it is preferred that the 6 or more degrees of freedom are rotational degrees of freedom, it is not excluded that at least one degree of freedom is a translational type. Preferably, the at least 6 degrees of freedom are of the roll and pitch type rotational degrees of freedom, in particular at least three roll and at least three pitch. It is imaginable that the at least one kinematic chain comprises at least four separate rotational axes, mutually connected by at least three links. As such, the at least one kinematic chain may be able to reach a variety of locations. The combination of the joints, links, and degrees of freedom determine the reachable domain of the at least one kinematic chain. By means of adapting the joints, i.e., from roll to pitch or vice versa, the reachable domain of the robotic energy converter may be adapted. Hence, the domain may be set according to the specific movement of a movable object, such as to allow the robotic energy to convert to follow essentially the entire movement thereof to extract energy from said movement. Preferably, the at least one kinematic chain is configured for moving outside a 2D-plane, preferably in a 3D-space. In particular, the at least three degrees of freedom of the at least one kinematic chain may allow for the kinematic chain to move out of a 2D-plane. However, it may be conceivable that the kinematic chain formed by a ball-joint and a link, is allowed for moving outside a 2D-plane.

It is conceivable that at least one joint of the kinematic chain is configured for making an endless rotation. This is in particular beneficial since no hard limit is imposed as to the movable object that is followed. Hence, the kinematic chain may have more operable freedom to move and hence extract more energy from the moveable object. It is also conceivable that two or more joints of the kinematic chain are configured for an endless rotation. For example, a wrist roll of a robotic arm may typically be endless.

Preferably, the at least one kinematic chain is at least partially formed by a robotic arm and/or robot manipulator. In particular it is preferred that the at least one robotic arm and/or robotic manipulator is essentially free of a counter mass. Such a counter mass is used very often in factories, and reduces the energy needed to move the robotic arm. However, in respect of the present invention, where said robotic arm and/or robot manipulator is used for extracting energy it is in fact desired to have the robotic arm free of counter masses. This provides a better potential energy to be extracted from a moving object. By means of a non-limitative example, an IRB 7600 type robotic arm may be used to form at least a portion of the at least one kinematic chain. Said robot arm may be adapted such as to be able to convert the movement of an object attached to an end of said arm into usable energy. In this respect, in particular the joints may be adapted to be able to convert the movement into energy. It has turned out that making use of a robotic arm is beneficial since it allows for six degrees of freedom providing the robotic energy converter with a large amount of flexibility to follow a movable object. Where, under conventional use of such a robotic arm and/or robot manipulator the links are kept at a predefined position. That is, in its resting condition, the kinematic chain of the robot does not collapse, which may be either due to an internal lock or by applying a predefined power (hydraulically and/or electrically) exerted onto the joints to lock the links of the robotic arm. However, it is preferred, for application in the present invention, that the joints and links are essentially freely movable. This may be understood as the movable object being able to transmit a random movement to the robotic arm (forming the kinematic chain) at any moment. Preferably, also in any random direction. It is conceivable that, if a robotic arm and/or robot manipulator forms the at least one kinematic chain, that the at least one base structure is formed by a base of the at least one robotic arm and/or robot manipulator. Optionally, the robotic energy converter, in particular the at least one robotic arm and/or robot manipulator is configured to lift the at least one movable object. It is preferred that lifting is executed by the robotic arm by using at least a portion of energy extracted from a movement of the at least one movable object. Hence, the robotic energy converter may be configured for both extracting energy and using energy, such as for lifting or moving purposes. Another non-limitative example thereof may be the lifting of a buoy or lifeboat. This is in particular when the base structure is for example mounted on a ship, wherein the robotic energy converter may be configured for extracting energy from buoy movement.

According to a preferred embodiment, the at least one kinematic chain is movably, preferably rotatably connected to the at least one base structure. This may provide a wider reach to the robot energy converter. Preferably, the connection between base structure and kinematic chain is at least rotatable in two directions, preferably around perpendicular axis. In this respect, preferably at least one rotational axis is extending in the longitudinal direction of the base structure, and at least one rotational axis is situated in a plane defined by the connection between the base structure and the at least one kinematic chain.

It is conceivable at least a portion of the at least one kinematic chain comprises a protective coating, preferably a corrosive protection coating. Yet, alternatives such as a sleeve, a rubber outer layer, a cover or a seal. It is preferred that at least one joint is covered by the protection. Joints of the kinematic chain may be prone to wear by for example dirt being in contact with the joint. Preferably, the at least one joint is substantially sealed from a surrounding. However, it is also conceivable that substantially the entire kinematic chain is covered by the protection. In the latter case, it is preferred that the protection allows for the movement of the kinematic chain with respect to the base structure to allow for movement to be converted into usable energy. A protection as described above may allow the robotic energy converter to be more widely applicable. For example, in an area close or in the sea or ocean. The salty air or moisture may be in particular harmful to the robotic energy converter, in particular the kinematic chain thereof. Yet, more variants may be conceivable, such as but not limited to: a robosuit, a coat, a pressurized suit. In the latter case a pressure sensor may be applied to check if the operating pressure is in a predetermined range.

Each robot joint is preferably also a sensor and may be used to provide feedback to the system and/or about the state of the joints. In case a single joint is not working anymore, due to the higher number of degrees-of-freedom the other joints may in such an instance take over. This would lead to a high availability of the system, i.e. minimize the required maintenance, maximize the energy use. Feedback of the joint status should be used to activate an alternative maximum generating motion profile.

It is imaginable that the last link of the at least one kinematic chain, in a direction from the base structure to the second end, is larger than the other links. Preferably, the length of the last link is situated between 2 m and 25 m, preferably between 5 m and 20 m, more preferably between 10 m and 15 m. By enlarging the last link, which is connected or connectable to the movable object a bigger range of motion may be followed, and hence more energy may be harvested.

Preferably, at least one link of the at least one kinematic chain is adjustable in its length direction for increasing or decreasing a range of motion of the at least one kinematic chain. This may allow the robotic energy converter to be more modular. Hence, where a fixed length link directly determines the range of motion of the robotic energy converter, an adjustable link may yield an adjustable range of motion of the robotic energy converter. As such, the robotic energy converter may be deployed in a wider range of situations, such as water level variations as a result of for example variation in tides, wind speed and/or wave length. It is preferred that the length of the adjustable link is set prior to installation thereof. However, it is also conceivable that the at least one adjustable link is in fact a dynamically adjustable link. Such as for example controlled by at least one controller or a control system. Said controller or control system may be configured for controlling the length of the at least one adjustable link. Preferably, said controller receives an input from one or more sensors. By having the at least one adjustable link, the robotic energy converted may be applied in more situations, without needing to alter one or more links or joints, which may be beneficial in respect of the design cost. Preferably, the robotic energy converter comprises at least one monitoring system, such as a camera, for monitoring of the at least one kinematic chain and/or the movable object. Said monitoring system may as such be connected to the controller. Monitoring a surrounding area of the at least one kinematic chain and/or the movable object is in particular preferred. According to a particular embodiment one or more cameras are arranged for determining upcoming movement of the movable object. The camera may for example determine a potentially harmful object is moving towards the movable object. Optionally, further comprising at least one control system for controlling the robotic energy converter, said at least one control system preferably comprising one or more sensors, for detecting upcoming movement or other details. Said controller or control system may be configured for actuating a part of the robotic energy converter, such as a link or joint, in respect of the sensory input. That may e.g., be in order to prevent a potentially harmful object from damaging the movable object. Therefore, the robotic energy converter preferably comprises at least one control system, wherein said control system is configured for actuating the at least one kinematic chain based on a predefined input signal. It is imaginable that said predefined input is received by said at least one control system from the at least one monitoring system.

According to a preferred embodiment of the present invention, the at least one kinematic chain is configured to communicate with at least a second kinematic chain, preferably a neighboring kinematic chain, more preferably all kinematic chains. The at least one robotic energy converter may comprise at least one control unit, preferably for controlling the at least one kinematic chain. It is also conceivable that each kinematic chain comprises a control unit for controlling a movement of said kinematic chain and/or communicating with a further kinematic chain. Preferably, the at least one kinematic chain may be configured to communicate via the least one control unit, which may be also referred to as a controller or a control system. The control unit may be configured to control the (re)positioning of at least one kinematic chain, in particular based on one or more environmental status parameters. It is imaginable that the robotic energy converter comprises one or more sensors, such as a radar, Lidar, Laser, satellite, wave sensor, camera, or the like, for measuring and/or detecting the one or more environmental status parameters. The one or more environmental status parameters may be chosen from the group of: wave height, wave length, wind speed, distance between neighboring kinematic chains, position of the at least one kinematic chain, position of the movable object, expected distance between neighboring kinematic chains, for example after a specific event, such as an extreme wave height. Preferably the at least one control unit is communicatively connected to at least one sensor, for receiving at least one environmental status parameter. Based on the at least one environmental status parameter, the control unit may be configured to control the (re)positioning of the at least one kinematic chain, for example (re)positioning with regard to its at least one neighboring kinematic chain. The (re)positioning of the at least one kinematic chain by the control unit may lead to an optimized spatial distribution of the at least one kinematic chain. Moreover, the control unit may allow to prevent collisions between adjacent kinematic chains of the robotic energy converter. This is especially important in case the at least one kinematic chain is able to move outside a 2D-plane, preferably in a 3D-space. This may lead to situations wherein the at least one kinematic chain may operate within the spatial range of at least a second kinematic chain. The control unit may prevent that adjacent kinematic chains damage one another. It is also conceivable that at least one sensor allows for detecting and/or monitoring and/or measuring a wave field. Preferably the at least one control unit is configured for optimizing an energy harvest based on the at least one wave field. This may for example be achieved by allocating the at least one kinematic chain to a position which has optimum waves, for example the highest waves, or the longest waves. To this end the control unit may comprise a maximum power point tracker. If is furthermore conceivable that the control unit is configured for adjusting a resonance frequency of the at least one kinematic chain for allowing the kinematic chain to reside in resonance to enlarge the amount of energy to be harvested.

It is conceivable that the movable object is a moveable floating body. In this respect, it may be imaginable that the robotic energy converter comprises at least three connections, for connecting the floating body to the fixed world, wherein first sides of the three connections engage at at least three separate locations on the floating body, and wherein second sides of the three connections engage, either directly or indirectly, on the fixed world, wherein the at least three connections allow the moveable floating body the freedom to move in at least one substantially vertical direction, and wherein at least one of the at least three connections is formed by the at least one kinematic chain. Due to the at least three connections engaging at at least three separate locations on the floating body the present invention may be able to extract more energy out of the waves. Therefore, the present invention is able to harvest more energy from the waves, and making it able to convert energy in a more efficient way compared to the prior art. Where in the present application reference is made to waves, in particular the movement of heave and surge of the waves and surface currents are meant. That is, the tide defines a base level of the water surface, and the waves define an amplitude along this base line. That is, the surface currents define a base mainly horizontal movement of the water, and the waves define an additional horizontal and vertical amplitude variation along this base line. The present invention in particular addresses the conversion of these waves that define the amplitude along the base level, hence the actual waves, and not the tidal fluctuations. The present invention in particular addresses also aim to compensate the surface currents with passive elements, hence the conversion of the waves that define the amplitude along the base level. It is known that a water particle near the water surface will make an orbiting movement when exposed to a single wave. The closer the water particle is situated towards the water surface, the larger the orbit of said motion will be. Therefore, in order to convert the most energy, a floating body may be used. On one side, the floating body is connected to a fixed world, with respect to which fixed world the floating body will move. The floating body is connected to the fixed world by means of the at least three connections, of which at least one is formed by the kinematic chain, wherein the at least three connections are situated such that the floating body is allowed to at least move in a substantially vertical direction, wherein said vertical movement is induced by the waves. The at least vertical movement is converted into usable energy by the at least one energy converting unit. The usable energy may for example be electrical energy, however, the movement may also be converted into a movement that drives a different apparatus. It is conceivable that the float

Preferably, the second sides of the at least three (or six, if optionally applied) connections engage at at least three separate locations on a first side of an intermediate platform. More in particular if the intermediate platform, at a side facing away from the three connections, is movable connected to the fixed world by means of at least one connecting arm. This allows for an easier placement of the robotic energy converter according to the present invention. Also, in case the connecting arm is movable, this allows for gradual adjustment of the level at which the intermediate platform is situated with respect to the water surface. As such, the robotic energy converter according to the present invention is not negatively affected by a change in tide. Preferably the connecting arm is automatically adjusted according to the actual tide level, such that the robotic energy converter is able to have a maximum efficiency at all times. That is especially due to the fact that placing the intermediate platform in accordance with the actual tide level, allows the floating body to make the biggest possible movements, which on its turn cause the most energy to be converted into usable energy. It is furthermore conceivable that the intermediate platform is provided with at least one connecting portion, which connecting portion is configured to engage with a locking portion of a different intermediate platform. As such, multiple intermediate platforms may be mutually releasably connected. To this end, it is preferred that each of the intermediate platforms is attached rigidly to the fixed world with a connecting arm, or wherein one intermediate platform is connected to the fixed world by such a connecting arm, and wherein the other intermediate platform is rigidly attached to said intermediate platform. Since movable floating body of the robotic energy converter according to the present invention is suspended from a side facing away from the water surface, the robotic energy converter does not negatively affect the marine live. In general, it is also conceivable that the movable floating body or another portion of the robotic energy converter, comprises at least one connector, for removably connecting the movable floating body, or another portion of the robotic energy converter, to the movable floating body, or another portion, of an adjacent robotic energy converter.

It is conceivable that the robotic energy converter comprises at least two kinematic chains, each comprising at least one link and at least one joint, wherein a first end of the at least two kinematic chains is, directly or indirectly, connected to the at least one base structure, and wherein a second opposite end of the at least two kinematic chains is connected or connectable to a movable object. Yet, it is also imaginable that a plurality of kinematic chains is provided. Each of the kinematic chains applied may be connected to different movable objects, or may be connected to the same movable object, or a combination thereof. It may be preferred to connect more than one kinematic chain to a common movable object depending on the forces, due to moving speed or mass of the object, exerted onto the kinematic chain(s). When more than one kinematic chain is connected to a single movable object, the combination of kinematic chains connected to said movable object may be referred to as a common kinematic chain. Preferably, the robotic energy converter comprises at least two base structures, wherein the at least two kinematic chains are each, directly or indirectly, connected to a respective base structure via their first ends. It is however conceivable that more than one kinematic chain is connected to each of the base structures. It is conceivable that the base structures are attached to e.g., an intermediate platform, wherein said intermediate platform may, directly or indirectly, be connected to the fixed world.

When more than one kinematic chain is applied, the at least two, preferably all, kinematic chains are connected to a shared DC or AC bus. By connecting more than one kinematic chain, or in particular, the output energy converted by a kinematic chain, variable output power may be reduced. At the same time, the reliability of the common output of the robotic energy converter. In respect thereof, connecting the energy, or power, output to a shared DC or AC bus may also be applied in respect of multiple robotic energy converters as such, and not only in respect of multiple kinematic chains. When connecting multiple kinematic chains to a common DC or AC bus, it is preferred that each kinematic chain, in particular the output of the generators thereof, is connected to the bus as such. The more kinematic chains or robotic energy converters are connected, the better the output load may be optimized and hence minimizing the variable output to provide for a more stable energy source.

The present invention is furthermore related to a ship and/or floating structure, wherein said ship and/or floating structure is provided with a robotic energy converter connected to the hull either under or above the water according to according to the present invention. It is conceivable that multiple robotic energy converters according to the present invention are connected either in parallel of series. Preferably further comprising a pulling mechanism to extract the movable object if necessary. In particular if the movable object is a buoy, floating on a surface of the sea. Although a ship is mentioned, the present invention is not limited thereto, the invention may similarly be applied in respect of an offshore windmill, a drilling rig, or other type of sea structure. Any fixed or moveable platform comprising at least a single robotic energy converter according to the present invention to generate energy in combination with other forms of renewable energy like a wind turbine and/or solar panels, where the robot could also be utilized, for example, to clean the solar panels. The robotic energy converter may also be located in or near a moon pool. Such a moon pool is often present on a marine drilling platform or drilling ship/support vessel. Yet, it may be conceivable that an artificial, in case of a floating body movable object, moon pool is formed. Such an artificial moon pool could be established by mean of a structure, e.g., plates, around the floating body movable object.

The present invention will hereinafter be elaborated on the basis of the follow non-limitative figures, wherein:

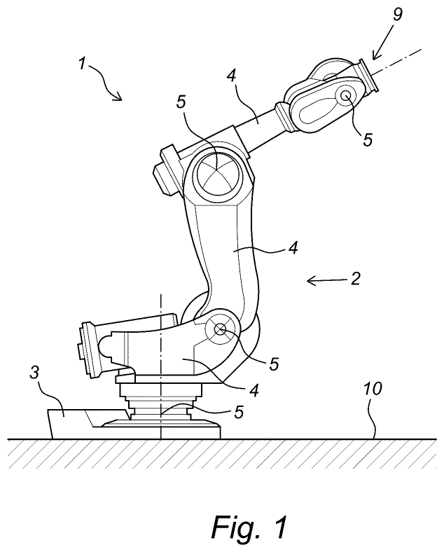

FIG. 1 shows a first embodiment of the robotic energy converter;

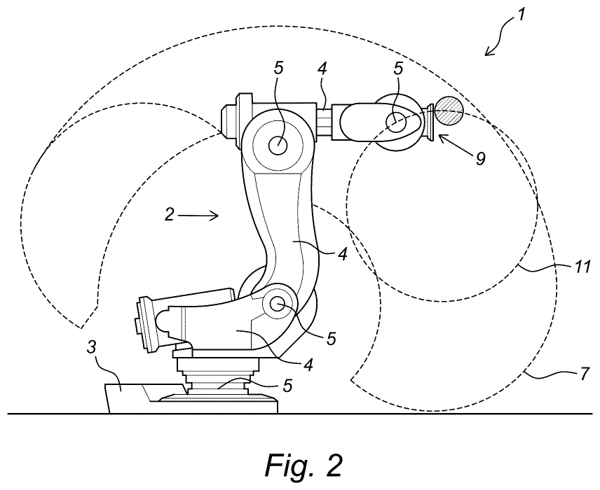

FIG. 2 shows a schematic view of the robotic energy converter; and

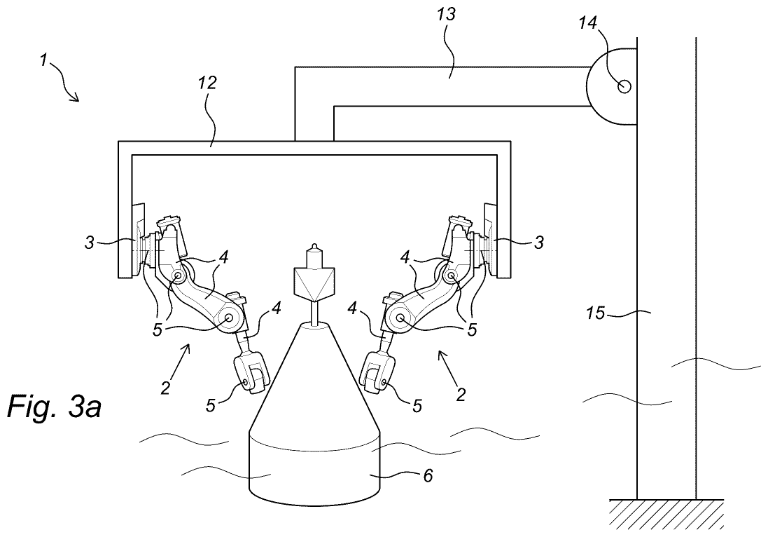

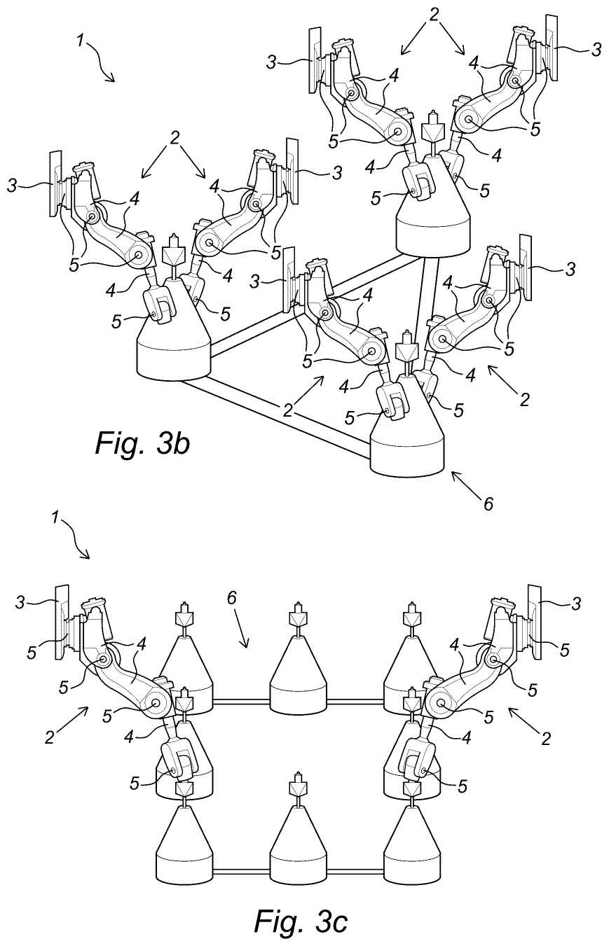

FIGS. 3a-3c show three different embodiments of the energy converter according to the invention.

FIG. 1 shows a first non-limitative embodiment of the robotic energy converter 1 according to the present invention. As shown in this figure, the robotic energy converter 1 is not connected to a movable object. A base structure 3 is mounted to a fixed world 10. In this embodiment the fixed world 10 is formed by a ground surface. However, the present invention is not limited thereto. It is conceivable that the fixed world may in fact be a ship, or other object that may form a point of reference for the robotic energy converter 1. A first end of a kinematic chain 2 is mounted to the base structure 3. Said connection between the kinematic chain 2 and the base structure is formed by a rotational joint 5. Hence, said kinematic chain 2 is movably mounted to the base structure 3. The kinematic chain 2 as shown in this figure comprises a total of three links 4 and four joints 5. The joints 5 are in this embodiment all formed by rotational joints 5, however it may be conceivable to apply a ball joint in respect of each of the joints 5. An end effector 9 of the kinematic chain 2 may be connected or connectable to a movable object. Once the end effector 9 is connected to the movable object, the kinematic chain 2 may be moved by said object. That is, the movement of the movable object may be transferred onto the kinematic chain 2. Said movement may cause the links 4 of the kinematic chain 2 to mutually rotate with respect to each other around the joints 5 of the kinematic chain 2. At least one, preferably each, of the joints 5 is formed by a generator, which generator may form an energy converting unit. Said energy converting unit, hence the generator formed by the joint 5, may convert the movement into usable energy, in particular electric energy. In this respect, it is in particular the mutual rotation movement between links 4 that may be converted into electrical energy. Since the robotic energy converter 1 as shown comprises a plurality of links 4 and joints 5, it comprises six degrees of freedom. The degrees of freedom are of benefit since it allows the robotic energy converter 1, in particular the kinematic chain 2 to follow a wide range of motions. This may be elaborated in more detail based on FIG. 2. FIG. 2 shows the robotic energy converter 1 as shown in FIG. 1, wherein a range of motion 7 of said kinematic chain 2 is indicated. Although, as shown, the range of motion 7 is relatively large, a subset range of motion 11 may be chosen as an operational domain 11 of said robotic energy converter 1. Said operational domain 11 may be determined by movement of a movable object. However, it is conceivable that a movable object has a larger movement compared to the range of motion 7 or the operational domain 11 of the kinematic chain 1. In the latter case, it may still be connected to an end effector 9. The movement of the movable object will in such instances be bounded by either the operational domain 11 or the range of motion 7 of the robotic energy converter 1. The range of motion 7 may be adapted by changing for example the links 4 and joints 5. However, the range of motion 7 may also be adapted by applying an extendable link 4. This may also allow for a dynamically adjustable range of motion 7 and/or a dynamically adjustable operational domain 11.

FIGS. 3a-3c show different operational embodiments of the robotic energy converter 1 according to the present invention. A first non-limitative embodiment is shown in FIG. 3a. According to this embodiment, the robotic energy converter 1 comprises two kinematic chains 2, wherein each of said kinematic chains 2 is connected, or mounted, on a respective base structure 3. Said base structures 3 are connected to an intermediate platform 12. Although, it may also be conceivable to connect the kinematic chains 2 directly to the intermediate platform, such that the intermediate platform 12 may form a common base structure for the two kinematic chains 2. The intermediate platform 12 is connected via a connecting arm 13. Said connecting arm 13 may be rotationally connected, via an axis 14 to a fixed world 15. In this particular embodiment, the fixed world 15 is formed by a pole of a windmill. Hence, the robotic energy converter 1 according to this embodiment is connected to a windmill 15. The movable object 6 is in particular a floating body 6, formed by a buoy 6. The buoy 6 may float on the water surface of the sea. The buoy will follow the movement of the waves, which is typically a circular like movement. The waves are repetitive in occurrence, and hence ideal for extracting a reliable source of energy. The two kinematic chains 2 are both connected to the buoy 6. As the buoy moves due to the waves, the kinematic chains 2 will move accordingly. As such, the movement of the movable object 6 causes the links 4 to mutually rotate with respect to each other around joints 5. The movement in said joints 5 may be converted at least partially into usable energy. This may in particular be convenient if one of said joints is formed by a generator. If the buoy drifts away due to the waves, at least a portion of the energy extracted from the movement may be used to pull the buoy 6 back. This may e.g., be done by actuating one of the kinematic chains 2. Hence, the movable object 6 may be reinstated to its initial position. The intermediate platform 12 as shown in this embodiment should not be considered restrictive. It is conceivable that alternative shapes are applicable. Also, the base structure 3 in this figure are mounted in a substantially vertical plane, which may equally be done via a horizontal mount. FIGS. 3b and 3c show yet two different embodiments of the robotic energy converter 1 according to the invention. In these embodiments, the movable object is also formed by a floating body 6. However, instead of a single buoy, the floating body comprises a plurality of interconnected buoys. According to the embodiment shown in FIG. 3b, two kinematic chains 2 are connected to each of the buoys. In FIG. 3c, two kinematic chains 2 are connected to two different buoys. The number of kinematic chains 2 and buoys may be altered in many ways, according to the space available, allowable movement of the floating body, and the desired energy to be extracted. The amount of energy extracted from the movement of the movable object may for example be increased by connecting more kinematic chains 2 to the movable object 6, as shown in FIG. 3b. However, it is also conceivable to replace the generator in one of the joints for a different generator with different specifications. The kinematic chains 2 shown in FIG. 3b may all be connected to a common DC or AC bus. However, alternatively it is also possible that the robotic energy converter 1 comprises two three parallel common DC or AC busses, wherein a combination of kinematic chains 2 may be connected in series or parallel thereto. This may allow for optimizing the power output, in particular the electrical power output of the robotic energy converter 1. Hence, said common DC or AC bus may allow for a more stable electricity output, which is favorable to the electricity network.

The above-described inventive concepts are illustrated by several illustrative embodiments. It is conceivable that individual inventive concepts, including inventive details, may be applied without, in so doing, also applying other details of the described example. It is not necessary to elaborate on examples of all conceivable combinations of the above-described inventive concepts, as a person skilled in the art will understand numerous inventive concepts can be (re)combined in order to arrive at a specific application and/or alternative embodiment.

The ordinal numbers used in this document, like “first”, “second”, and “third” are used only for identification purposes. Hence, the use of expressions like a “second” component, does therefore not necessarily require the co-presence of a “first” component.

1-25. (canceled)

26. Robotic energy converter, for converting movement of a movable object into on average usable energy, in particular electrical energy, comprising:
at least one base structure, wherein said base structure is, directly or indirectly, connected or connectable to a fixed world,
at least one kinematic chain comprising at least one link and at least one joint, wherein a first end of the at least one kinematic chain is, directly or indirectly, connected to the at least one base structure, and wherein a second opposite end of the at least one kinematic chain is connected or connectable to a movable or moving object,
wherein the robotic energy converter comprises at least one energy converting unit, for converting the movement of a movable object connected to the second end of the kinematic chain into usable energy, preferably electrical energy.

27. Robotic energy converter according to claim 26, wherein the energy converting unit comprises at least one generator, in particular a rotational generator, wherein at least one joint of the at least one kinematic chain is at least partially formed by said generator, for converting a rotation of a link connected to said joint into usable energy.

28. Robotic energy converter according to claim 27, wherein the at least one energy converting unit comprises a plurality of generators, wherein each joint of the at least one kinematic chain is at least at least partially formed by at least one generator, for converting rotational movement between adjacent links into usable energy.

29. Robotic energy converter according to claim 26, wherein the at least one kinematic chain is configured for moving outside a 2D-plane, preferably in a 3D-space.

30. Robotic energy converter according to claim 26, wherein the at least one kinematic chain comprises at least 3 or more degrees of freedom.

31. Robotic energy converter according to claim 30, wherein the at least one kinematic chain comprises at least four separate rotational axis, mutually connected by at least three links.

32. Robotic energy converter according to claim 26, wherein the base structure is mounted in a substantially vertical position and/or wherein the at least one kinematic chain is suspended to or from the at least one base structure.

33. Robotic energy converter according to claim 26, wherein the at least one kinematic chain is at least partially formed by a robotic arm and/or robot manipulator.

34. Robotic energy converter according to claim 26, wherein the at least one kinematic chain is movably, preferably rotatably connected to the at least one base structure.

35. Robotic energy converter according to claim 26, wherein the at least one link, preferably all links, of the at least one kinematic chain are substantially rigid or flexible links.

36. Robotic energy converter according to claim 26, wherein at least one link of the at least one kinematic chain is adjustable in its length direction for increasing or decreasing a range of motion of the at least one kinematic chain.

37. Robotic energy converter according to claim 26, wherein the movable object is a moveable floating body.

38. Robotic energy converter according to claim 37, wherein the robotic energy converter and/or floating body comprises at least one stabilizing element, preferably a submersed or submersible element, such as a plate, for stabilizing the floating body.

39. Robotic energy converter according to claim 37, wherein the robotic energy converter and/or floating body comprises at least one flow conducting element, for introducing a movement into the at least one floating body through a fluid flow.

40. Robotic energy converter according to claim 26, wherein the base structure is mounted, preferably to the fixed world, in a substantially vertical direction and/or wherein at least one link and/or at least one joint comprises at least one actuator, for actuating said at least one link and/or said at least one joint.

41. Robotic energy converter according to claim 26, wherein the robotic energy converter comprises at least two kinematic chains, preferably independently movable, each comprising at least one link and at least one joint, wherein a first end of the at least two kinematic chains is, directly or indirectly, connected to the at least one base structure, and wherein a second opposite end of the at least two kinematic chains is connected or connectable to a movable object.

42. Robotic energy converter according to claim 40, wherein the robotic energy converter comprises at least two base structures, wherein the at least two kinematic chains are each, directly or indirectly, connected to a respective base structure via their first ends.

43. Robotic energy converter according to claim 40, wherein the at least two kinematic chains, preferably all kinematic chains are configured to communicate, preferably via at least one control unit, preferably wherein the control unit is configured for independently controlling the at least two kinematic chains, preferably all kinematic chains based on at least one environmental status parameter.

44. Robotic energy converter according to claim 26, wherein the robotic energy converter comprises at least one monitoring system, such as a camera, for monitoring of the at least one kinematic chain and/or the movable object and/or wherein the robotic energy converter further comprises at least one control unit and/or a control system, wherein said control unit and/or control system is configured for actuating the at least one kinematic chain based on a predefined input signal, preferably wherein said predefined input is received by said at least one control system from the at least one monitoring system.

45. Ship and/or floating structure provided with a robotic energy converter connected to the hull either under or above the water according to claim 37.
